(19) United States
(12) Patent Application Publication
(10) Pub. No.: US 2002/0050720 A1
(43) Pub. Date: May 2, 2002

(54) Coupling device for door locking systems

(76) Inventor: Michael Helmer, Bad Soden (DE)

Correspondence Address: Martin A. Farber, Suite 473, 866 United Nations Plaza, New York, NY, 10017, US

(21) Appl. No.: 09/957,675

(22) Filed: Sep. 19, 2001

(30) Foreign Application Priority Data
Sep. 21, 2000 (DE) 100 46 731. 8

(51) Int. Cl. E05C 3/06

(52) U.S. Cl. 292/216

(57) ABSTRACT

A coupling device serves for transmitting force from door handles to a lock latch. In this case, a coupling element (26, 28) in a first position ensures positive engagement between connecting elements (12, 14) of the door handles and a driver element (16) of the lock latch. In a second position of the coupling element (16) the positive engagement is canceled. In order to achieve a further locking function, with the smallest possible outlay, it is made possible to move the coupling element into a third position in which there is only a positive engagement between one connecting element (14) and the driver element (16).

The invention is concerned with a coupling device for door locking systems for the positive transmission of actuating forces from at least two door handles to a retaining pawl of a door lock, the coupling device being provided with a respective connecting element for an outside door handle and inside door handle, a driver element for connection to the retaining pawl and a coupling element which can be moved into a first position in which it produces the positive engagement between the two connecting elements and the driver element, and into a second position in which the positive engagement between the connecting elements and the driver element is canceled.

Coupling devices of this type, in which the positive engagement with the locking means in the locked state of the door can be canceled, are preferred over those devices which block the mechanism, since forcible pulling on the door handles subject said devices under some circumstances to extremely high loads which may damage the mechanism.

It is already known to provide a coupling device of the type described at the beginning, in which case a separate coupling device has to be provided if an additional function is desired, such as a child-proof lock in which unlocking may only be permitted by actuating the outside door handle. However, this considerably increases the structural outlay which has the effect of increasing the required structural space as well as the costs.

The object of the present invention is to provide a simplified coupling device which with the smallest possible outlay permits a further locking function.

According to the invention, the object is achieved by a coupling device of the type described at the beginning in which the coupling element can be moved into a third position in which only the connecting element of one door handle interacts positively with the driver element while the connecting lever of the other door handle is uncoupled from the driver element.

By means of the additionally approachable position of the coupling element, the coupling device according to the invention makes possible a further locking function without having to provide a separate coupling device. The extra mechanical outlay can be minimized and also only a small amount of space is required, which is advantageous in many installation situations.

In the third position the outside door handle is preferably connected positively via its connecting element to the driver element, so that the child-proof lock which is generally desired on the rear doors of vehicles can be realized.

Although the coupling device according to the invention can also be used in the case of elements which are moved linearly, in a preferred development of the invention provision is made for the connecting elements and the driver element to be mounted rotatably on an axis, and for the coupling element to be movable essentially radially between its positions. In this form of construction, the forces which occur can be readily governed in a very small constructional space and the frictional losses in the deflecting mechanism are particularly small.

It is particularly preferred to arrange the connecting elements and the driver element which are made of sheet metal in layered form.

The formation of the individual elements from sheet metal of sufficient strength makes possible, in conjunction with the arrangement where they lie one above another, a particularly small constructional space depth and also the bending of the elements can be restricted to a minimum enabling particularly stiff levers to be formed. The last point is particularly advantageous if, after a relatively severe accident, higher actuating forces than customary were to be necessary in order to unlock the retaining pawl.

In a further preferred embodiment, the coupling element has a bolt-like element which can be moved in a radial clearance between the connecting elements and the driver element, one connecting element having a driver extending radially into the region of the first position of the bolt-like element and the other connecting element having a driver extending into the region of the third position of the bolt-like element.

The formation of the coupling element as a short bolt, pin, shoulder, integrally formed projection or the like results in particularly high rigidity making possible the transmission of forces between the positions of the connecting elements and the driver element. In the first position, all three elements are connected positively to one another, in the third, central position only one connecting element and the driver element are connected, and in the second position, in which the coupling element assumes its radially outermost position, the connecting elements are uncoupled from the driver element, i.e. the door is locked.

The coupling element is furthermore preferably preloaded in the direction of its first position with the aid of a spring element, in which case when the coupling element is released the movement from the second position via the central, third position into the first position takes place.

In combination with a feature which is preferably likewise realized and according to which at least one actuating element for the coupling element is provided with play which enables the coupling element to undertake a certain relative movement with respect to the at least one actuating element, a memory function can be achieved. It is thereby ensured that with the coupling element temporarily blocked, for example as a consequence of a door handle being pulled, a switching process under the action of the spring element takes place after the door handle concerned has been let go, without renewed actuation, for example of the central locking system, being necessary.

Preferably, two separate actuating elements are provided, a first actuating element being provided for moving the coupling element between the first and second position, and the second actuating element being provided for moving the coupling element into the third position. In this case, the first actuating lever serves for locking and unlocking the door while the second actuating lever permits the child-proof lock to be switched on.

In accordance with the connecting elements and the driver element, the actuating elements may likewise be manufactured from sheet metal, the two actuating elements preferably being adjustable about a common pivot axis.

It is readily conceivable to drive at least one actuating lever by motor, in which case the first actuating lever preferably has an electric or pneumatic drive in order to realize the operation customary these days for central locking systems.

The connection between the actuating elements and the coupling element is preferably achieved by the coupling element having at least one pin-like element, so that it can be carried along by the two actuating elements. At least one pin element preferably sits in a slot in an actuating element, the position and size of which slot is dimensioned in such a manner that the actuating element concerned is able to carry along the coupling element into the desired position and in the process ensures that the two actuating elements do not obstruct each other by means of the coupling element and the coupling element has the desired clearance of movement for the memory function.

In a further preferred embodiment of the invention, a lock ejection means can be provided which can be achieved by an operative connection between the connecting element of the inside door handle and the first actuating element, so that in the event of an emergency actuation of the inside door handle makes unlocking possible, by movement of the coupling element into its radially innermost position.

An exemplary embodiment of the invention will be discussed in greater detail below with reference to the attached drawings, in which:

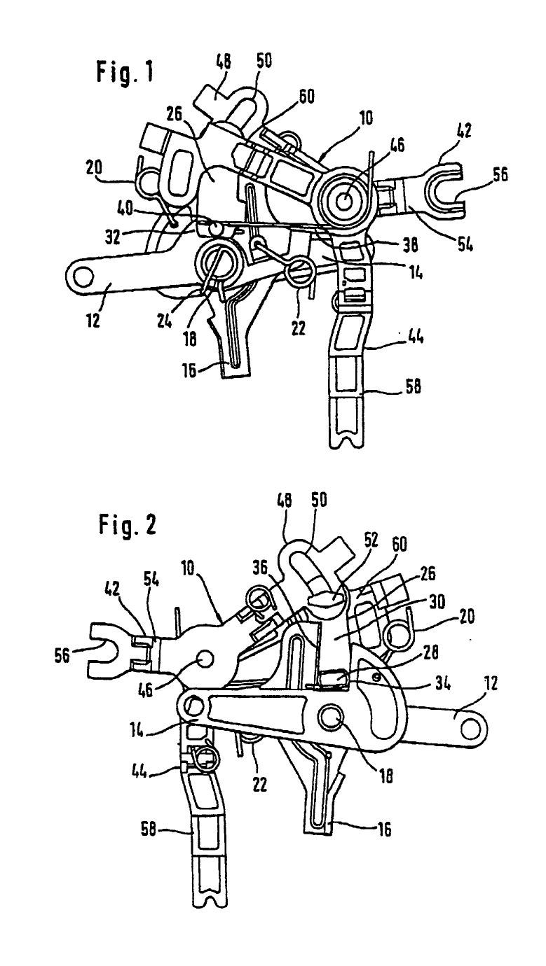

FIG. 1 shows a coupling device of a door lock in the unlocked state;

FIG. 2 shows a view from the rear of the coupling device according to FIG. 1;

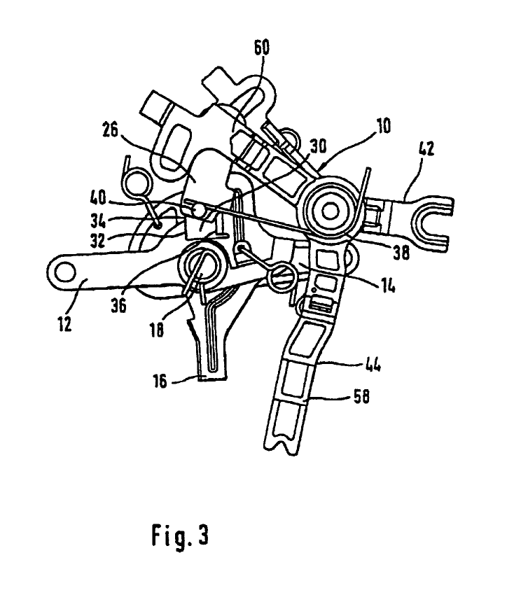

FIG. 3 shows a front view of the coupling device according to FIG. 1 with the door lock in the “child-proof lock” position;

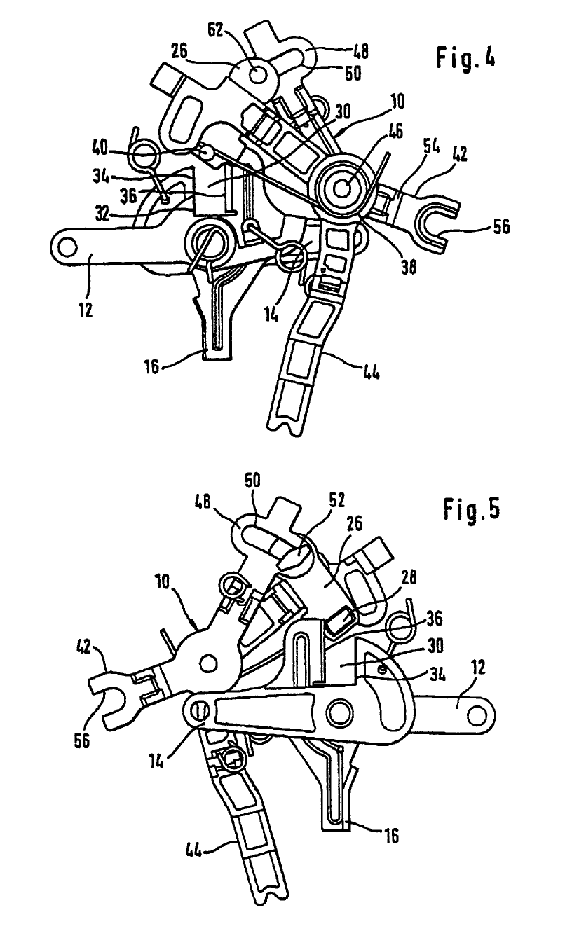

FIG. 4 shows a view of the coupling device according to FIG. 1 with the door lock locked;

FIG. 5 shows a view from the rear of the coupling device in the position according to FIG. 4.

FIG. 1 illustrates a coupling device 10 which is connected between the door handles (not illustrated) and the retaining pawl (likewise not shown) of a door lock, in particular a motor vehicle door lock or tailgate, and which realizes the various locking functions which are required.

The coupling device 10 has a first connecting lever 12 which is connected to the inside door handle, a second connecting lever 14 which is connected to the outside door handle, and a driver lever 16 which interacts with a retaining pawl (not shown) and, as it pivots, opens the latter. The retaining pawl and the driver lever may also be formed integrally. The two connecting elements 12, 14 and the driver element 16 consist in each case of sheet metal of a strength suitable for transmitting the forces required and are mounted in a manner such that they can pivot about a common axis defined by a bolt 18. Restoring springs 20, 22, 24 are provided in order to secure the two connecting levers 12, 14 and the driver lever 16 in their rest position.

The two connecting elements 12, 14 and the driver element 16 are designed in such a manner that there is no positive engagement between them themselves. This positive engagement for transmitting the actuating forces from the door handles to the retaining pawl can be achieved by a coupling element 26 having a bolt-like projection 28 which is movable radially in a gap 30 which is bounded by a first carry-along flank 32 of the first connecting lever 12 and a second carry-along flank 34 of the second connecting lever 14 on the one side, and by a subsequent flank 36 of the driver lever 16 on the other side. The first carry-along flank 32 has the smallest radial extent, the second carry-along flank 34 has a medium radial extent and the subsequent flank 36 has the largest radial extent. A retaining spring 38, which acts on the coupling element 26 via a pin 40, attempts to retain said coupling element in its radially innermost position in which the bolt-like projection 28 whose length of course reaches over the depth of the two connecting elements 12, 14 and of the driver element 16, produces a positive engagement between the two connecting levers 12, 14 and the driver lever 16. In this first position of the coupling element 26, the existing positive engagement causes the door lock to be in its released position.

The coupling device 10 furthermore has a first actuating lever 42 and a second actuating lever 44 which can be pivoted about a common rotational axis defined by a further bolt 46. The bolt 46, which can be integrally formed on the lever 42 or welded to it, also provides support for the retaining spring 38 of the coupling element 26. Provided on a lever arm 48 of the first actuating lever 42, in a region covered by the coupling element 26, is a slot 50 which is formed in the circumferential direction about the rotational axis of the first actuating lever 42 and into which a pin 52 connected to the coupling element 26 protrudes (see FIG. 2). In the unlocked door-lock position which is illustrated in FIGS. 1 and 2, the actuating lever 42 is also in its rest position and the pin 52 bears against, or is in the vicinity of, that end of the slot 50 which faces the gap 30.

A claw 56 in which a driver element of a preferably electrically driven central locking drive engages is formed on a second lever arm 54 of the first actuating lever 42. Actuation of the drive causes the first actuating lever 42 to pivot into the position illustrated in FIGS. 4 and 5, where, by carrying along the pin 52 and therefore the coupling element 26, the projection 28 which produces the original positive engagement is moved radially outward in the gap 30, with the result that said projection passes out of the engagement region of the two driver flanks 32, 34. The positive engagement between the two connecting levers 12, 14 and the driver element 16, against whose subsequent flank 36 the projection 28 still bears even in this radial outer position, is thereby canceled, so that unlocking of the door is not possible either by actuating the inside door handle or by actuating the outside door handle. The door lock is consequently in its locked position.

The second actuating lever 44 serves to keep the coupling element 26, and therefore the bolt-like projection 28, in a central radial position (see FIG. 3) between the two radial positions shown in FIG. 1 and FIG. 4. In this respect, the second actuating lever 44 can be pivoted via an adjusting arm 58 into the child-proof lock position which is shown in FIG. 3 and is locked by a bistable spring element, for example. As a result, the retaining arm 60 of the second actuating lever 44 is also pivoted into a position at a greater distance from the rotational axis of the two connecting levers 12, 14, in which case a bearing edge (not visible) which interacts with a child-proof lock bolt 62 ensures that when the door lock is unlocked, the coupling element cannot pass into its radially innermost position, as is illustrated in FIGS. 1 and 2, but remains in a central radial position in which the bolt-like projection 28 of the coupling element 26 lies outside the engagement region of the first driver flank of the first connecting lever 12, but still in the engagement region of the second driver flank 34 of the second connecting lever 14. In consequence, the positive engagement between the first connecting lever 12 and the driver lever 16 is canceled while opening of the door by actuation of the outside door handle is made possible by the continuing positive engagement between the second connecting lever 14 and the driver lever 16. In this case, the pin 52 of the coupling element 26 is in a central position in the slot 50 in the first actuating lever 42, so that when the latter is pivoted into the locking position of the door lock, said pin is carried along only over the last section between the central and radially outer position of the coupling element 26.

The retaining spring 38 also ensures a memory function of locking positions. If, for example, the coupling element is situated in the radially outer position illustrated in FIGS. 4 and 5, and subsequently, when, for example, the outside door handle is pulled and the door lock is unlocked, i.e. the first actuating lever 42 pivots into the position shown in FIGS. 1 and 2, the coupling element 26 cannot pass into its radially inner position because of the gap 30 which is blocked by the second driver flank 34. However, because of the slot 50, which is designed to be of a sufficient length, the pivoting movement of the first actuating lever 42 is not impeded and the pin 52 of the blocked coupling element 26 correspondingly moves in the slot 50. If, subsequently, the outside door handle is let go and, as a result, the second driver flank 34 is moved out of the gap 30, the coupling element 26, and therefore the bolt-like projection 28, can snap into the gap 30, under the action of the retaining spring 38, and can produce the positive engagement between the two connecting levers 12, 14 and the driver lever 16.

A further conceivable function, which is not realized in the embodiment depicted, relates to a lock ejection means which is intended to make it possible to unlock the door lock by actuating the inside door handle in the locked state. For this purpose, a suitable operative connection between the first connecting lever 12 and the first actuating lever 42 can be provided which is able, when the child-proof lock is switched on and also without directly opening the retaining pawl, to ensure that the door lock switches over into the unlocked state, so that a subsequent opening of the door from the outside or, when the child-proof lock is switched off, from the inside and outside, is made possible.

1. A coupling device for door locking systems for the positive transmission of actuating forces from at least two door handles to a lock latch of a door lock, the coupling device being provided with a respective connecting element (12, 14) for an outside door handle and inside door handle, a driver element (16) for connection to the lock latch and a coupling element (26, 28) which can be moved into a first position in which it produces the positive engagement between the two connecting elements (12, 14) and the driver element (16), and into a second position in which the positive engagement between the connecting elements (12, 14) and the driver element (16) is canceled, characterized in that the coupling element (26, 28) can be moved into a third position in which only the connecting element (14) of one door handle interacts positively with the driver element (16) while the connecting lever (12) of the other door handle is uncoupled from the driver element (16).

2. The coupling device as claimed in claim 1, characterized in that in the third position the outside door handle is connected positively via its connecting element (14) to the driver element (16).

3. The coupling device as claimed in claim 1 or 2, characterized in that the connecting elements (12, 14) and the driver element (16) are mounted rotatably on an axis, and the coupling element (26, 28) can be moved essentially radially between its positions.

4. The coupling device as claimed in one of the preceding claims, characterized in that the connecting elements (12, 14) and the driver element (16) consist of sheet metal and are arranged in layered form.

5. The coupling device as claimed in claim 3 or 4, characterized in that the coupling element (26) has a bolt-like element (28) which can be moved in a radial clearance (30) between the connecting elements (12, 14, 32, 34) and the driver element (16, 36), one connecting element (12) having a driver (32) extending radially into the region of the first position of the bolt-like element (28) and the other connecting element (14) having a driver (34) extending into the region of the third position of the bolt-like element (28).

6. The coupling device as claimed in one of the preceding claims, characterized in that the coupling element (26) is preloaded in the direction of its first position with the aid of a spring element (38), in which case when the coupling element (26) is released movement from the second position via the central, third position into the first position takes place.

7. The coupling device as claimed in one of the preceding claims, characterized in that two separate actuating elements (42, 44) are provided, a first actuating element (42) being provided for moving the coupling element (26) between the first and second position, and the second actuating element (44) being provided for moving the coupling element into the third position and for keeping it in the third position.

8. The coupling device as claimed in one of the preceding claims, characterized in that at least one actuating element (42, 44) for the coupling element (26) is provided with play which enables the coupling element to undertake a certain relative movement with respect to the at least one actuating element (42, 44).

9. The coupling device as claimed in claim 7 or 8, characterized in that the actuating elements (42, 44) are manufactured from sheet metal.

10. The coupling device as claimed in one of claims 7 to 9, characterized in that the two actuating elements (42, 44) can be adjusted about a common pivot axis.

11. The coupling device as claimed in one of claims 7 to 10, characterized in that at least one actuating element (42, 44) is motor-driven.

12. The coupling device as claimed in claim 11, characterized in that the first actuating lever (42) has an electric or pneumatic drive.

13. The coupling device as claimed in one of claims 7 to 12, characterized in that the coupling element (26) has at least one pin-like element (52, 62), so that it can be carried along by the two actuating elements (42, 44).

14. The coupling device as claimed in claim 13, characterized in that at least one pin element (52) of the coupling element (26) sits in a slot (50) in an actuating element (42).

15. The coupling device as claimed in one of claims 7 to 14, characterized in that a lock ejection means is provided which comprises an operative connection between the connecting element (12) of the inside door handle and the first actuating element.
